(19) United States
(12) Patent Application Publication
(10) Pub. No.: US 2026/0165320 A1
(43) Pub. Date: Jun. 18, 2026

(54) COMPOSITION FOR CONTROLLING PLANT VIRUSES CONTAINING LEVAN AS AN EFFECTIVE INGREDIENT AND METHOD FOR CONTROLLING PLANT VIRUSES USING THE SAME

(71) Applicant: KNU-Industry Cooperation Foundation, Gangwon-do (KR)

(72) Inventors: Hyunjun KO, Gangwon-do (KR); Hangil KIM, Gangwon-do (KR); Sangrea SHIM, Gangwon-do (KR); Yong Sik KIM, Gangwon-do (KR)

(21) Appl. No.: 19/416,018

(22) Filed: Dec. 11, 2025

(30) Foreign Application Priority Data
Dec. 17, 2024 (KR) 10-2024-0188367

(51) Int. Cl. A01N 43/08; A01P 1/00

(52) U.S. Cl. CPC A01N 43/08; A01P 1/00

(57) ABSTRACT

Provided are a composition for controlling plant viruses containing levan as an effective ingredient and a method for controlling plant viruses using the composition.

### CROSS-REFERENCE TO RELATED APPLICATION

This application claims the benefit of and priority to Korean Patent Application No. 10-2024-0188367, filed on Dec. 17, 2024, the entire disclosure(s) of which is hereby incorporated herein by reference in its entirety.

### FIELD

The present disclosure relates to a composition for controlling plant viruses containing levan as an effective ingredient and a method for controlling plant viruses using the composition.

### BACKGROUND

Levan, a β-2,6-linked fructan, is a biopolymer that exhibits excellent water solubility, high viscosity, biocompatibility and biodegradability, and is also free of toxic effects. Based on these properties, levan has various physiological benefits such as prebiotic effects, antioxidant and antidiabetic effects, anti-tumor effects and a wide range of industrial applications (Dobrange, Peshev, Loedolff, & Van den Ende, 2019; Domżał-Kȩdzia, Ostrowska, Lewińska, & Łukaszewicz, 2023; Mohd Nadzir, Nurhayati, Idris, & Nguyen, 2021).

Levan is also reported to be involved in the immune regulation of living organisms by inducing the expression of inflammatory cytokines, including interleukins and tumor necrosis factors (Magri et al., 2020; Van Dyk, Kee, Frost, & Pletschke, 2012; Xu et al., 2016a), increasing spleen cell proliferation (Liu et al., 2010; Xu et al., 2016a), and stimulating macrophages (Park et al., 2008; Zhang et al., 2019).

Regarding the antiviral effect closely related with immunomodulatory effect of levan, Esawy et al. (2011) demonstrated the in vitro antiviral capability of levan produced from six strains of Bacillus subtilis against adenovirus type 40 (Esawy et al., 2011), and more recently, Gamal et al. evaluated the antiviral activity of three types of levan (crude, dialyzed, and sulfated) produced from Enterococcus faecalis isolates against the Newcastle disease virus (Gamal, Hashem, El-Safty, Soliman, & Esawy, 2020). These studies suggest the potential of levan as an antiviral agent, but considering that few studies have been conducted on the antiviral effects of levan in plant and agricultural fields to date, detailed investigations are needed.

In agriculture, viral diseases such as cucumber mosaic virus (CMV) pose significant challenges, leading to substantial crop yield losses globally.

CMV is a plant virus with a wide range of hosts and is reported to infect over 100 families and more than 1,200 species of plants (Matsuo et al., 2007), causing significant damage to major crops and fruit trees worldwide, leading to substantial yield losses. Further, CMV is a major plant virus with a high degree of genetic variation because it infects various plant species and a high potential for distribution through non-persistent transmission by aphids (Gildow et al., 2008; Perry, Zhang, Shintaku, & Palukaitis, 1994). Although plants have, as antagonist to CMV, various antiviral mechanisms such as autophagy in hosts, systemic acquired resistance (SAR), and R gene-mediated resistance embedded in host plants (Brigneti et al., 1998; Mayers, Lee, Moore, Wong, & Carr, 2005; Shukla et al., 2022; Takahashi et al., 2012), CMV effectively avoids these antiviral responses via RNA silencing suppressor 2b protein, rendering the host's antiviral mechanism ineffective. Therefore, a CMV control strategy that effectively enhances the overall antiviral mechanisms in the host to induce resistance to the virus in the host is required.

The disclosure focuses on the production and characterization of levan by purification by Paenibacillus polymyxa SG09-12 and its application as an antiviral agent against CMV. The applicant aims to elucidate the mechanisms by which the levan modulates the immune response in plants and assess its effectiveness in controlling viral infections to analyze the antiviral effects of levan against CMV in detail. By understanding the antiviral effects of levan, the applicant also aims to develop sustainable and environmentally friendly strategies for managing plant viral diseases, thereby improving crop resilience and productivity.

Korean Patent No. 10-2024-0130914 published in Aug. 30, 2024 is an example of the related art.

### SUMMARY

An object of the present disclosure is to provide a composition for controlling plant viruses containing levan as an effective ingredient.

Another object of the present disclosure is to provide a method for controlling plant viruses using the composition for controlling plant viruses containing levan as the effective ingredient.

In an aspect, the present disclosure provides a composition for controlling plant viruses containing levan as an effective ingredient.

In another aspect, an object of the present disclosure is to provide a pesticide composition with plant virus control activity including the composition for controlling plant viruses containing levan as the effective ingredient.

In another aspect, an object of the present disclosure is to provide a composition for fertilizer additive with plant virus control activity including the composition for controlling plant viruses containing levan as the effective ingredient.

In yet another aspect, an object of the present disclosure is to provide a method for controlling plant viruses including a step of treating plants or soil with the composition for controlling plant viruses containing levan as the effective ingredient.

According to aspects of the present disclosure, levan exhibits an excellent and long-lasting antiviral effect against plant viruses.

### BRIEF DESCRIPTION OF THE DRAWINGS

FIGS. 1a, 1b, 1c, 1d and 1e show the comparison of levan biosynthetic performances by Paenibacillus sp. T9 and SG9-12;

FIGS. 2a, 2b, 2c, 2d, 2e and 2f show the results of HPLC analysis of purification and homogeneity of Paenibacillus levan;

FIGS. 3a, 3b, 3c, and 3d show the results of a comparative analysis of CMV infection disease symptoms and the amount of viral RNA according to the presence or absence of levan treatment;

FIGS. 4a, 4b, 4c and 4d show the global gene expression pattern and differential expression gene (DEG) of the RNA-seq library according to the presence or absence of levan treatment; and

FIG. 5 shows an expression pattern of a gene related to disease resistance according to the presence or absence of levan treatment.

### DETAILED DESCRIPTION

### Overview

The disclosure investigates the application of levan produced from Paenibacillus polymyxa SG09-12 as an antiviral agent against cucumber mosaic virus (CMV).

High-purity microbial levan was produced and purified using diafiltration. The chemical composition, structure, and functional groups of the levan were characterized by high-performance liquid chromatography (HPLC), nuclear magnetic resonance (NMR), Fourier-transform infrared spectroscopy (FT-IR), and x-ray photoelectron spectroscopy (XPS).

The antiviral effect of levan was evaluated in Nicotiana tabacum plants infected with CMV. Treatment with purified levan significantly mitigates viral disease symptoms and reduces viral replication, demonstrating excellent and long-lasting antiviral effects and highlighting its potential as an antiviral agent. This antiviral effect may have been mediated by transcriptional activation of disease-resistant genes encoding RPP13.

The finding enhances the understanding of levan produced by Paenibacillus species and its application as an antiviral defense mechanism, contributing to sustainable and environmentally friendly crop protection strategies.

In an aspect, the present disclosure provides a composition for controlling plant viruses containing levan as an effective ingredient.

In the present disclosure, levan is produced by Paenibacillus polymyxa, although aspects are not limited thereto.

In an example of the present disclosure, the plant virus may be tobacco mosaic virus (TMV), pepper mottle virus (PepMoV), cucumber mosaic virus (CMV), pepper mild mosaic virus (PMMoV), zucchini yellow mosaic virus (ZYMV), watermelon mosaic virus (WMV), watermelon mosaic virus 2 (WMV2), potato virus Y (PVY), turnip mosaic virus (TuMV), melon necrotic spot virus (MNSV), cucumber green mottle mosaic virus (CGMMV), zucchini green mottle mosaic virus (ZGMMV), potato leafroll virus (PLRV), lily mottle virus (LMoV), lily symptomless virus (LSV), odontoglossum ringspot virus (ORSV), cymbidium mosaic virus (CyMV), broad bean wilt virus (BBWV), tomato ringspot virus (TomRSV), tobacco ringspot virus (TRSV), tomato spotted wilt virus (TSWV), strawberry mottle virus (SMoV), or cactus X virus (CVX).

In another example of the present disclosure, the plant virus is a cucumber mosaic virus (CMV).

The composition for controlling plant viruses according to the present disclosure may be formulated in various forms known in the field of pesticides, and any formulation method commonly used in the field of pesticides may be used for the formulation.

Therefore, in an example, the composition for controlling plant viruses according to the present disclosure may be formulated in the form of, for example, liquid, granule, powder, emulsion, oil, wettable powder, or spreader, but aspects are not limited thereto.

The composition for controlling plant viruses according to the present disclosure may include various components for the formulation such as, for example, liquid carrier, solid carrier, surfactant, or adjuvant.

Water, vegetable oil, ethanol, and the like may be used as the liquid carrier, and the vegetable oil includes soybean oil, rapeseed oil, palm kernel oil, palm kernel oil, rice bran oil, corn oil, palm oil, olive oil, and the like, although aspects are not limited thereto.

As the solid carrier, mineral powder, gelatin, alginic acid, and the like may be used, although aspects are not limited thereto.

As the mineral powder, cation clay, bentonite, kaolin, talc, diatomaceous earth, and the like may be used, although aspects are not limited thereto.

As the surfactant, ethylene oxide-based surfactant, diethanolamine-based surfactant, sorbitol-based surfactant, glycerin-based surfactant, and the like may be used, although aspects are not limited thereto.

As the adjuvant, one or more filler, antifreeze, solvent, thickener, film former, and the like may be used, although aspects are not limited thereto.

Levan may be contained in an amount of 0.5 to 2.0 wt %, or 0.7 to 1.5 wt % with respect to the total weight of the composition for controlling plant viruses. When the levan is less than 0.5 wt % with respect to the total weight of the composition for controlling plant viruses, the effect of levan on controlling plant viruses may be negligible. In addition, when the levan exceeds 2.0 wt % with respect to the total weight of the composition for controlling plant viruses, the effect of increasing antiviral activity may not be significant compared to the content of the administered levan.

The concentration of levan contained in the composition for controlling plant viruses according to the present disclosure may be appropriately adjusted by a person skilled in the art in consideration of the plant growth status, cultivated field environment, the severity of plant virus diseases, and the like.

In another aspect, the present disclosure provides a pesticide composition with plant virus control activity, which includes the composition for controlling plant viruses containing levan as the effective ingredient.

In yet another aspect, the present disclosure provides a composition for fertilizer additive with plant virus control activity, which includes the composition for controlling plant viruses containing levan as the effective ingredient.

The levan according to the present disclosure has antiviral activity against plant viruses, and thus may be added to pesticides, fertilizers, and the like for the prevention, treatment, or mitigation of diseases caused by the plant viruses.

The pesticide composition or composition for fertilizer additive according to the present disclosure may include general components known in the art (e.g., solvents, carriers, emulsifiers, dispersants, adjuvants, and the like) in addition to levan, which is an effective ingredient, although aspects are not limited thereto.

In yet another aspect, the present disclosure provides a method for controlling plant viruses, which includes a step of treating plants or soil with the composition for controlling plant viruses containing levan as the effective ingredient.

In an example, the treating step may include foliar application, soil treatment, immersion treatment, branch treatment, treatment applied to sterilization of agricultural equipment, and the like, although aspects are not limited thereto.

Hereinafter, certain examples of the present disclosure will be described in more details. However, the following examples are provided for illustrative purposes only and are not intended to limit the scope of the disclosure.

### EXAMPLES

### 1. Materials and Methods

### 1.1. Bacterial Strain, Plant Materials, and Virus Inoculum

Two Paenibacillus strains, P. polymyxa SG09-21 and P. kribbensis T-9, were isolated from soil samples collected from garlic and Chinese cabbage fields in Samcheok, Gangwon Province, Republic of Korea, respectively (Xu, Hong, Choi, & Kim, 2014; Xu, Park, Kim, & Kim, 2016b). The bacteria were cultured in yeast extract-peptone-dextrose (YPD) media consisting of 1% yeast extract, 2% peptone, and 2% dextrose at 30° C.

For solid media, 2% Bacto agar was added to the YPD media. The media were purchased from BD Difco (Franklin Lakes, NJ, USA).

Nicotiana benthamiana plants were used for maintaining the CMV virus inoculum. N. tabacum cv. BY4 were used for challenging inoculation of CMV. All the plants were grown in a growth chamber under a 25° C. condition with a 16 h day/8 h night period. A representative strain of CMV subgroup IA, CMV-Fny, was used for the virulence test.

Standard levan was purchased from CellapyBio (Daejeon, Korea).

Carbohydrate polymer standards with molecular weights ranging from 630,000 to 3,755,000 were purchased from American Polymer Standards (Mentor, OH, USA).

All the other chemicals were purchased from Sigma-Aldrich (St. Louis, MO, USA).

### 1.2. Production and Purification of Microbial Levan by Paenibacillus sp

Microbial levan was produced in yeast extract-peptone-sucrose (YPS) media containing 1% yeast extract, 2% peptone, and 5% sucrose.

A seed culture was prepared using YPD broth at 30° C. for 16 h and inoculated into 50 mL of YPS broth at a 1:50 ratio. The main culture was performed at 30° C. and 180 rpm, for 5 days.

Samples were collected daily during incubation for quantitative analysis of saccharides (sucrose, glucose, fructose, and levan). The saccharides analysis was performed using high-performance liquid chromatography with a refractive index detector (HPLC-RID, YL9100 series, Youngin Chromass, Anyang, Korea). Sugar KS-802 and KS-806 columns (Showa Denko K. K., Tokyo, Japan) were used for saccharides quantification and molecular weight determination of the produced levan, respectively. HPLC-grade water was used as the mobile phase at a flow rate of 1 mL/min. The column and the detector were maintained at 50° C.

For the purification of levan, ultrafiltration was used. To this end, first, cells were removed by centrifugation at 8,000 rpm for 20 min. The levan in the supernatant was purified using a 100 kDa nominal molecular weight cutoff (NMWC) ultra-centrifugal filter (Merck, Rahway, NJ, USA) at 3,000 rpm. Distilled water was used for the diafiltration. At each step of the purification process, 200 μL samples were collected and analyzed by HPLC to determine the purity of levan.

### 1.3. Elucidation of Chemical Structure of Levan Produced From P. polymyxa SG09-12

The homogeneity of the produced levan was verified by HPLC analysis after acid hydrolysis. Briefly, 20 μL of concentrated sulfuric acid was added to 2 mL of the purified levan, and the mixture was autoclaved. The hydrolyzed monosaccharides were analyzed by HPLC as described above.

¹H and ¹³C nuclear magnetic resonance (NMR) spectra of the purified levan were obtained using a Fourier-transform (FT)-NMR 600 MHz spectrometer (Bruker Avance Neo 600, Germany). The ¹H NMR spectrum was recorded with 128 scans, while the ¹³C NMR spectrum was acquired with 1024 scans.

The functional groups of the purified levan were analyzed using a Fourier-transform infrared (FT-IR) spectrometer (IR Tracer-100, Shimadzu, Japan) equipped with an attenuated total reflectance accessory. FT-IR spectrum was recorded in the range of 4,000-500 cm⁻¹ at a resolution of 4.0 cm⁻¹ with 128 scans.

To analyze the elemental distribution on the surface of the levan sample, X-ray photoelectron spectroscopy (XPS) was performed using a K-Alpha+ instrument (Thermo Scientific, UK). XPS spectra were acquired with a dwell time of 30 ms and 30 scans.

### 1.4. In-Planta Antiviral Activity Test

To evaluate the plant antiviral effect of the purified levan, a composition containing 1.0 wt % of levan was prepared and sprayed onto tobacco seedlings, after which the tobacco seedlings were inoculated with CMV to check for disease symptoms.

Specifically, approximately 2 mL of levan solution was sprayed onto the leaves of the prepared tobacco plants, and 3 days after the levan treatment, the plants were mechanically inoculated with CMV through fluid inoculation as previously described (Atarashi et al., 2020).

The inoculation sap was prepared by grinding 0.1 g of CMV-infected N. benthamiana leaves in 1 mL of 0.1 M phosphate buffer (pH 7.1). Then, the virus was inoculated into three leaves of each plant, and carborundum was used as an abrasive in the rubbing process.

The virus symptoms were observed at 5 and 21 days post-inoculation (dpi).

### 1.5. Quantitative RT-PCR (qRT-PCR)

To compare the viral RNA levels in plants infected with CMV, semi-time and real-time qRT-PCR analyses were performed. Total RNA was extracted from the infected plant tissues using the IQeasy plus Plant RNA Extraction Mini Kit (iNtRON, Daejeon, Korea) following manufacturer's instruction. The extracted RNA was subjected to reverse transcription using Reverse Transcriptase XL (AMV) (Takara, Ohtsu, Shiga, Japan) and random primers to synthesize first-strand complementary DNA (cDNA).

For the semi-time qRT-PCR, the viral cDNA was amplified by 20 and 25 cycles of PCR using Ex Taq polymerase (Takara) and CMV-specific primers under optimized conditions. A partial messenger RNA (mRNA) sequence of elongation factor 1α (EF1α) was amplified as a reference control using a specific primer-pair. The PCR products were separated on a 1.5% agarose gel, and intensities of the band were measured to quantify the relative levels of viral RNA.

For the real-time qRT-PCR, TB Green Premix Ex Taq II (Takara) was used with the same primer-pair used for the semi-qRT-PCR. Data from the real-time qRT-PCR were analyzed using the method of 2\hat{ }(-ΔCt) as previously described (Livak & Schmittgen, 2001).

### 1.6. Transcriptome Sequencing and Bioinformatics Analysis

To elucidate the molecular mechanisms of antiviral effects induced by levan treatment in N. tabacum, we generated RNA-seq reads for 4-week-age seedlings. The method described above was used to extract RNA from the seedling treated with levan or distilled water (mock) at 3 days post-treatment. RNA sequencing (RNA-seq) was performed on RNA samples obtained from three biological replicates.

Prior to performing RNA-seq, the quantity and quality of RNA samples were verified using Qubit 4.0 (Invitrogen, Carlsbad, CA, USA), Nanodrop 2000 (Thermo Fisher Scientific, Cleveland, OH, USA), and 2100 Bioanalyzer (Agilent Technologies, Santa Clara, CA, USA). Only RNA samples with a total RNA amount of 1 μg or more and an RNA integrity number (RIN) of 7 or more were used for RNA-seq library construction. RNA-seq libraries were constructed using the TruSeq Strand mRNA library construction kit according to the manufacturer's protocol (Illumina, San Diego, CA, USA). RNA-seq was performed using the Illumina NovaSeqX platform (Illumina).

RNA-seq reads were trimmed to remove sequencing adapters and low-quality bases using Trim Gallore with default parameters (www.bioinformatics.babraham.ac.uk/projects/trim_galore/). Then, the trimmed reads were aligned to the reference genome sequence of N. tabacum in consideration of the high-confidence genetic model (zenodo.org/records/8256256) (Sierro, Auberson, Dulize, & Ivanov, 2024), using HISAT2 (v2.2.1) (Kim, Paggi, Park, Bennett, & Salzberg, 2019). The aligned reads were aligned using a Samtools alignment algorithm that uses the default parameters (v1.10) (Li et al., 2009). The number of reads mapped to the gene set of the reference genome was calculated using the HTSeq-count algorithm in union mode (v1.99.2), ignoring secondary and supplementary alignments (Anders, Pyl, & Huber, 2015).

Based on the number of reads, differential gene expression between levan-treated and mock-treated seedlings was confirmed using DESeq2 (v1.38.2) (Love, Huber, & Anders, 2014).

### 2. RESULTS AND DISCUSSION

### 2.1. Production of Paenibacillus Levan

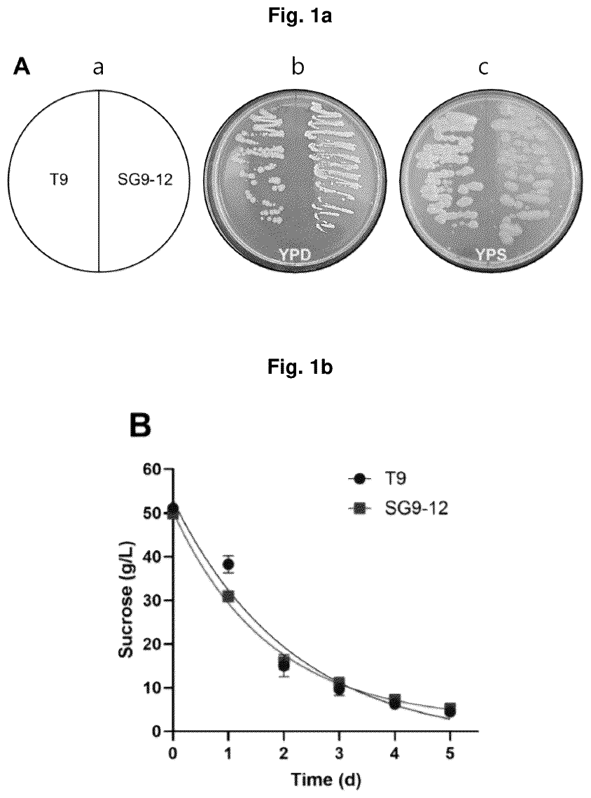

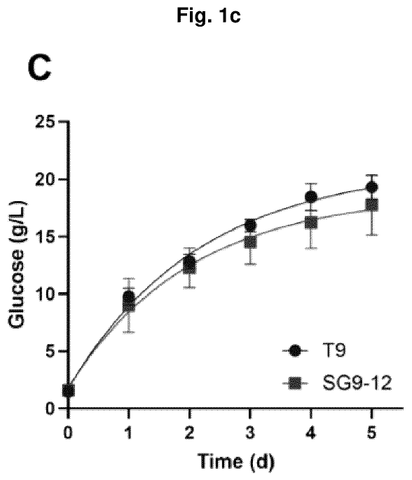

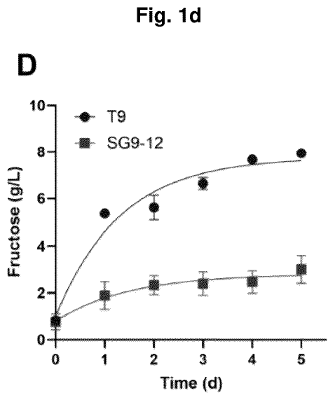

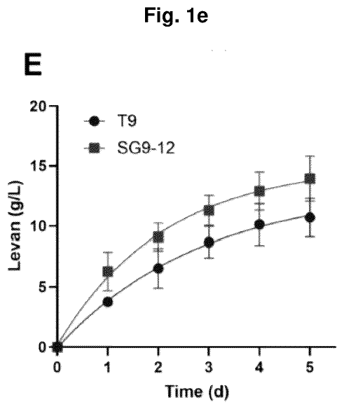

Paenibacillus sp. are well-known producers of various exopolysaccharides (EPSs) depending on the species and carbon sources used (Rütering, Schmid, Rühmann, Schilling, & Sieber, 2016). On media provided with sucrose as the sole carbon source, the levan-producing strains exhibit a distinct mucoid phenotype. Based on this phenomenon, we identified levan production from both SG09-12 and T-9 strains (FIG. 1A).

In the YPS broth culture, both P. polymyxa SG09-21 and P. kribbensis T-9 strains showed similar sucrose consumption and glucose production yield (FIGS. 1B and 1C), and the calculated final substrate consumption yield was 91.4±1.0% and 89.4±0.9%, respectively. However, the yield of liberated fructose was significantly different. T- 9 produced 7.9±0.1 g/L fructose, whereas SG 09-12 produced only 3.0±0.4 g/L fructose (FIG. 1D).

Levansucrase (EC 2.4.1.10) synthesizes levan through a series of reactions involving sucrose hydrolysis followed by transfructosylation (polymerization), known as the “ping-pong” mechanism (Meng & Fütterer, 2003). Therefore, to evaluate levansucrase activity, researchers have suggested using the ratio of transfructosylation to hydrolysis activity (T/H) (Xu, Ni, Yu, Zhang, & Mu, 2018). The calculated T/H value of SG09-12 was 4.91, which is 3.4-fold higher than that of T- 9 (1.43), leading to a higher levan production titer for SG09-12 under the tested condition (FIG. 1E). Based on these results, the strain SG09-12 was selected for the following experiments.

FIG. 1 shows the comparison of levan biosynthetic performances by Paenibacillus sp. T9 and SG9-12.

FIG. 1A shows the phenotypic exopolysaccharide formation of two Paenibacillus species. Two Paenibacillus species (T9 and SG9-12) were cultured on glucose and sucrose-containing media to detect exopolysaccharides formation.

Specifically, FIG. 1A shows the result of evaluating the levan biosynthetic performance of two Pannibacillus strains on selective media, in which (a) shows an overview of medium partitioning, (b) shows the morphology of colonies grown on glucose medium, and (c) shows the morphology of colonies grown on sucrose medium.

FIGS. 1B to 1E show graphs of comparative analysis of the levan biosynthetic efficiency of two kinds of Pannibacillus strains according to incubation time. FIG. 1B shows sucrose consumption, FIG. 1C shows glucose production, FIG. 1D shows fructose production, and FIG. 1E shows levan biosynthetic performance. Glucose production by sucrose consumption showed similar patterns in both strains, but the amount of fructose produced showed distinct differences. This shows that the SG9-12 strain has a better efficiency of producing levan, a fructose polymer. As shown in FIGS. 1B to 1E, the optimum Paenibacillus strain producing levan was selected by comparing hydrolysis and fructosylation activity during broth culture.

### 2.2. Characterization of Levan Produced by SG09-12

To characterize the levan produced by SG09-12, it was purified using ultrafiltration.

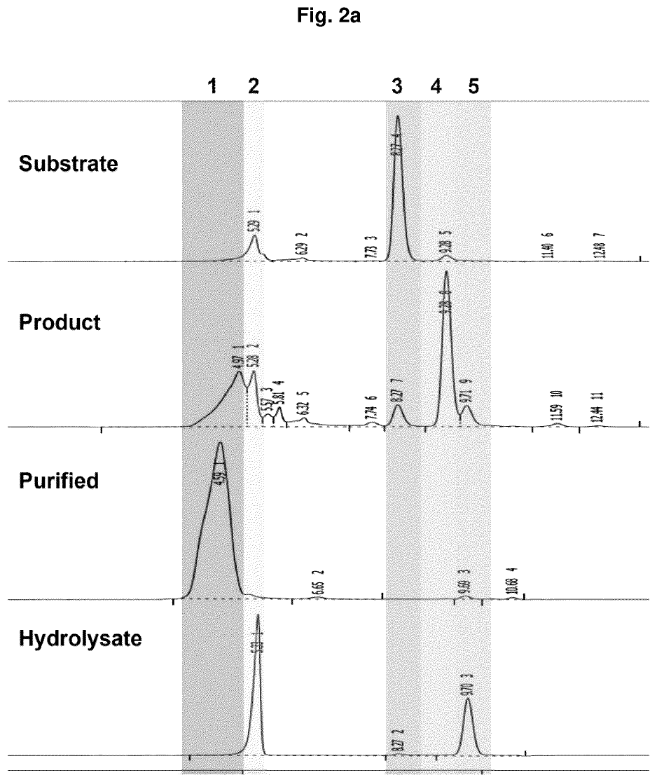

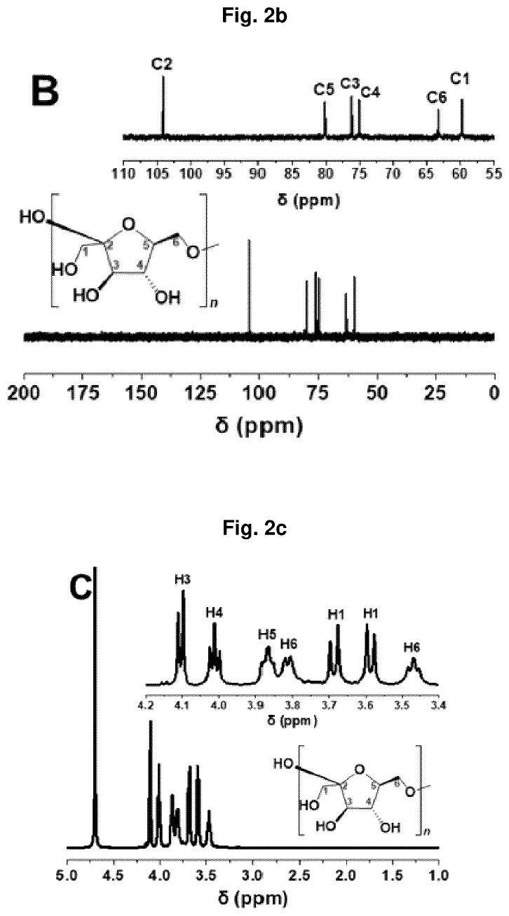

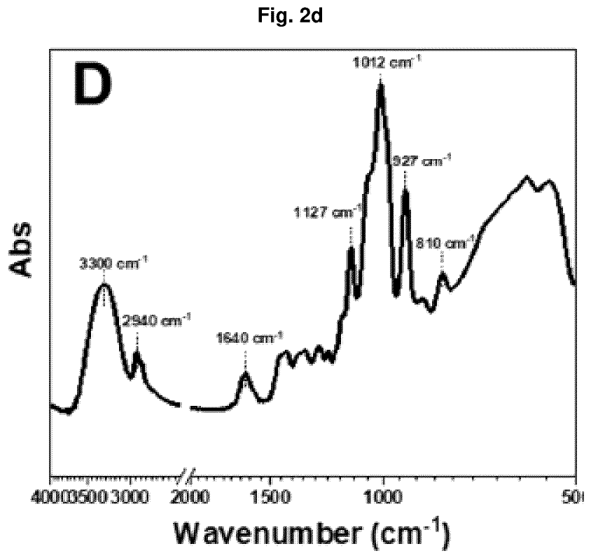

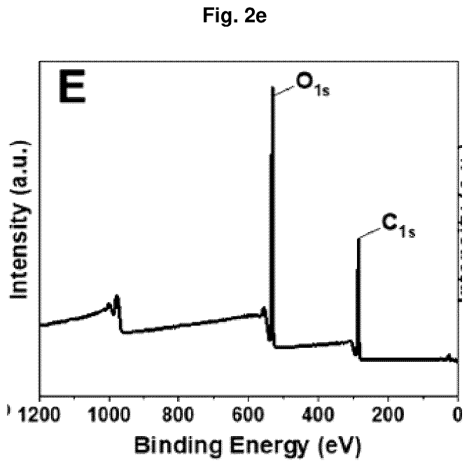

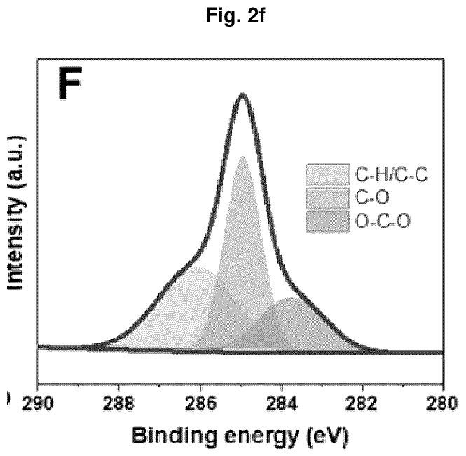

FIG. 2 shows the results of HPLC analysis of purification and homogeneity of Paenibacillus levan.

As showed in FIG. 2A, the YPS culture supernatant of SG09-12 was composed of media residues (yeast extract and peptone) and various saccharides, including levan, fructo-oligosaccharides, unreacted sucrose, liberated glucose, fructose, and some organic acids as byproduct (FIG. 2A).

Ethanol precipitation is the most favored method for the purification of microbial EPS. However, this method is not suitable for use in protein-rich media because it requires additional protein elimination steps involving trichloroacetic acid treatment (Pintado et al., 2020).

Since the YPS media used herein is typical protein-rich media, the NMWC method was adopted. Using a 100 kDa filter, the 2.44×105 Da levan was clearly purified. Levansucrase takes a wide range of fructosyl acceptors, including saccharides, organic alcohols, and aromatic compounds (Öner, Hernández, & Combie, 2016). Consequently, microbial levan can form heteropolymers depending on the given conditions. In particular, P. polymyxa produces various EPSs including glucose, fructose, galactose, mannose, rhamnose, and xylose (Huang et al., 2024).

To verify the homogeneity of the produced levan in the study, HPLC analysis was conducted after acid hydrolysis. As shown in FIG. 2A, the chromatogram of the hydrolyzed product is almost entirely composed of fructose (96.7%), indicating that the levan produced by SG09-12 is a homopolysaccharide (Rütering et al., 2016).

FIG. 2A shows the HPLC chromatogram of levan products and puriﬁed levan according to the culture of Paenibacillus strain SG 9-12, in which (1) shows levan, (2) shows media and buffer, (3) shows sucrose, (4) shows glucose, and (5) shows fructose. After incubation, sucrose in the substrate was converted into levan, glucose, and fructose, and the produced levan was purified simply by ultrafiltration/diafiltration. As a result of analyzing the produced and purified levan after acid hydrolysis, almost all of the constituent sugars of the levan were found to be fructose.

The chemical structure of levan was analyzed using ¹³C and ¹H NMR spectroscopy (FIGS. 2B and 2C).

¹³C NMR spectroscopy provides detailed insights into the chemical molecular structure of levan, enabling precise characterization and comparison of branched and linear forms (Seymour, Knapp, Zweig, & Bishop, 1979). In the ¹³C NMR spectrum, the levan produced by P. polymyxa exhibited six characteristic carbon signals at δ104.2, 80.2, 76.3, 75.2, 63.3, 59.8 ppm, corresponding to C 2, C 5, C 3, C 4, C6, and C1, respectively. This indicated the presence of β-(2→6)-linked fructofuranosyl units, consistent with previously reported chemical shifts (Han, Xu, Gao, Liu, & Wu, 2016; Korany, El-Hendawy, Sonbol, & Hamada, 2021; Osman, Lin, & Hwang, 2023; Shimamura et al., 1987; Xu, X. et al., 2016).

Levan is a natural homopolysaccharide consisting of D-fructofuranosyl residues connected by β-(2→6) linkages. In instances of branched levan, additional β-(2→6) linkages are present within the branch chains (Seymour et al., 1979; Shimamura et al., 1987). However, no distinct signals of other carbon signals or downfield shift of the dominant C3 signal were observed in this study, suggesting that the purified levan sample predominantly includes linear β-(2→6)-linked fructofuranosyl units, without additional carbon signals originating from branching points other than β-(2→6) linkages (Seymour et al., 1979; Xu, X. et al., 2016).

In the ¹H NMR spectrum, the signals obtained from the purified levan at the 3.45-4.11 ppm region were associated with protons in polysaccharide molecules, including those in fructose. All signals of the purified levan structure were confirmed to correspond in detail to the hydrogen signals of the repeating fructose monomer, indicated as positions 1 to 6. Additionally, the splitting patterns exhibited consistent integral ratios. The ¹H NMR spectrum of the purified levan showed a resonance pattern almost identical to those described in previous literature (Bruni, Qi, Terrell, Dupre, & Mattison, 2024; Charoenwongphaibun et al., 2023; Han et al., 2016; Korany et al., 2021). Each proton and carbon signal was assigned to the repeating unit structure, verifying the high purity of levan.

The chemical structure of purified levan was further analyzed using FT-IR spectroscopy as shown in FIG. 2D. The strong and broad peak at 3300 cm⁻¹ was attributed to the O—H stretching vibration of the levan, while the peaks in 2940 and 2890 cm⁻¹ corresponded to C—H stretching vibrations. The absorption peak at 1640 cm⁻¹ was attributed to O—H bending vibrations, likely indicating the presence of water in the levan polymer. Three prominent peaks at 1127, 1060, and 1012 cm⁻¹, were primarily attributed to ring vibrations overlapping with the stretching vibrations of C—OH groups and the glycosidic linkage (C—O—C). Additionally, the characteristic peaks at 927 and 810 cm⁻¹ corresponded to the symmetric stretching vibrations of the furanose ring (Zhang et al., 2018).

XPS provided further insights into the elemental composition and chemical environment of levan (FIGS. 2E and 2F). Two main peaks corresponding to C1s (285 eV) and O1s (531 eV) were observed. The constituent elements of purified levan included 57.51 % carbon and 42.16% oxygen. The C1s core level of purified levan was deconvoluted into three types of curves at 286.1 eV, 285.0 eV, and 283.7 eV, corresponding to C—H/C—C, C—O, and O—C—O, respectively, in the C1s core-level spectrum (Song & Seo, 2024). Overall, the combined data from NMR, FT-IR, and XPS analyses provide robust evidence validating the chemical structure of levan produced by P. polymyxa SG09-12.

The polysaccharide characteristics of produced levan were analyzed: ¹³C NMR (FIG. 2B), ¹H NMR (FIG. 2C), FT-IR (FIG. 2D), XPS survey scan (FIG. 2E), and C1s core-level (FIG. 2F).

As a result of NMR and XPS analysis, the produced levan was identified as a high-purity fructose polymer with beta-2,6 linkages between fructose, and the vibration of hydroxy groups, glycoside linkages, and furanose rings was identified as a result of functional analysis, verifying that the produced polymer was a levan.

### 2.3. Levan-Mediated CMV Resistance in Tobacco

To evaluate the effect of levan treatment on CMV infection, we tested viral infectivity in levan-treated tobacco plants.

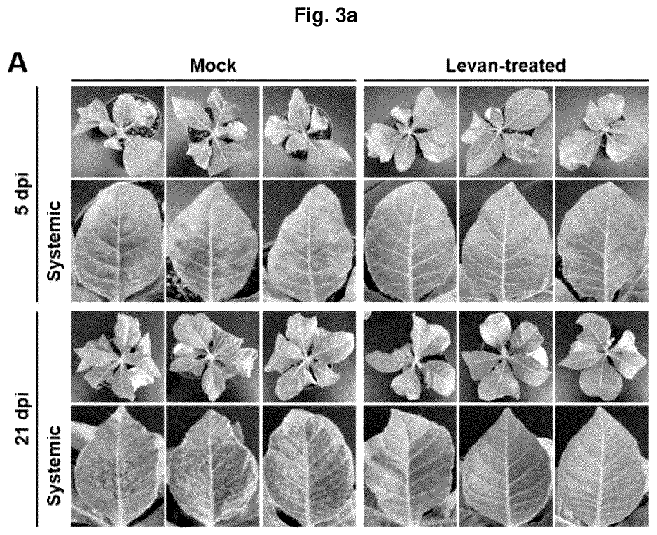

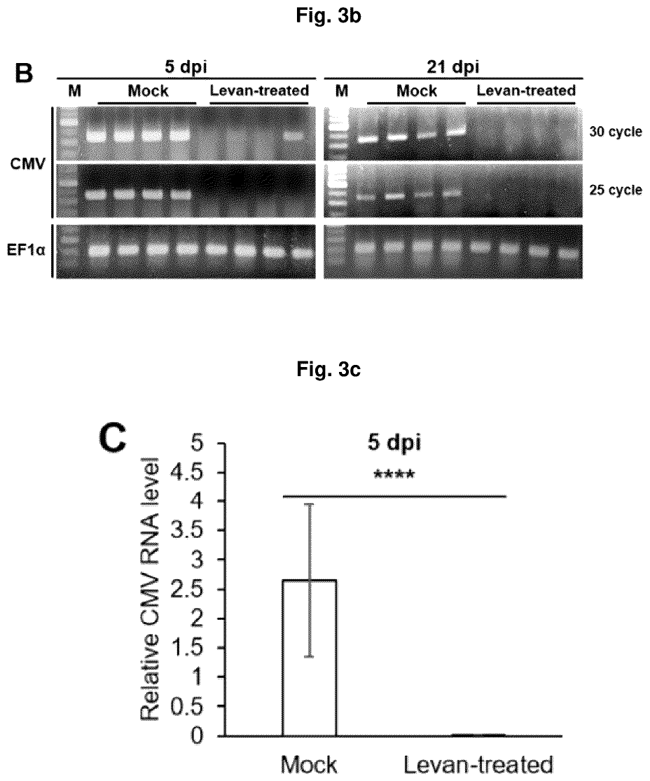

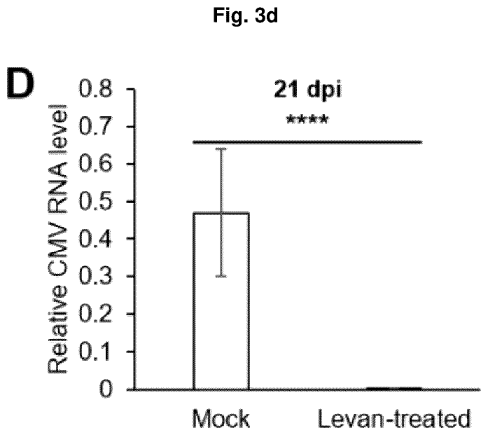

Levan and DW were first sprayed on the leaves of tobacco plants, and 3 days later, CMV was mechanically inoculated by sap-inoculation. At 5 dpi, systemic vein clearing with yellow mosaic symptoms was detected only in mock-treated plants (FIG. 3A), and levan-treated plants were asymptomatic.

Consistent with the observed symptoms, the semi-time and real-time qRT-PCRs using CMV RNA 3-specific primers showed a substantial reduction in viral RNA levels in systemic leaves of the levan-treated plants (FIGS. 3B and 3C).

Unlike the bacterial treatments of another Paenibacillus species, P. lentimorbus, which has previously been reported that it enhanced tobacco growth conferring tolerance against CMV infection (Kumar et al., 2016), according to our study, the treatment of the levan did not visibly affect plant growth compared to growth on plants not treated with levan (FIG. 3A).

To test the long-term resistance in tobacco, CMV symptoms were compared on newly generated systemic leaves at 21 dpi. As shown in FIG. 3A, leaf malformation and shrinking symptoms with yellow mosaic symptoms were detected on newly infected leaves of the mock-treated plants, while symptoms were still significantly restricted in the levan-treated plants. Overall, viral accumulation levels in upper leaves of the mock-treated plants were significantly higher than in control plants (FIGS. 3B to 3D). These results suggest that the effect of levan treatment on CMV infection has been maintained for a long time.

FIG. 3 shows the results of a comparative analysis of CMV infection disease symptoms and the amount of viral RNA according to the presence or absence of levan treatment. Specifically, FIG. 3 shows the analysis results of disease symptoms and virus concentration in tobacco leaves at 5 and 21 days post CMV inoculation, following 3 days of treatment with the culture media containing levan.

FIG. 3A shows symptoms of CMV-infected N. tabacum plants at 5 and 21 dpi, with images of uninoculated upper leaves (systematic).

FIG. 3B is an RT-PCR analysis for comparison of CMV RNA levels, and the numbers of PCR cycles are given at the right side of each gel images. Partial EF1α sequence was amplified as a control.

FIGS. 3C and 3D represent comparisons of CMV RNA levels between mock-treated and levan-treated BY 4 plants through quantitative real-time RT-PCR at 5 dpi (FIG. 3C) and 21 dpi (FIG. 3D). The mean (±SEM) values were log-transformed for the Student's t-test (****P<0.0001).

The observation of viral disease symptoms and quantification of viral RNA confirmed that overall disease progress was significantly delayed in the case of levan-treated test subjects, and the accumulation of viral RNA was greatly suppressed.

### 2.4. Global Transcriptional Changes in Levan-Treated Tobacco Plants

To explore the molecular mechanisms of antiviral resistance against CMV infection induced by levan treatment, transcriptomic analysis of levan-treated and mock-treated seedlings was performed.

A total of 48,815,296 to 59,241,702 RNA-seq reads were generated from six RNA-seq libraries. After trimming, an equal number of RNA-seq reads were maintained and used for transcriptome mapping. Of the trimmed reads, an average of 93.7% of the trimmed reads were successfully aligned to the reference genome sequence of N. tabacum.

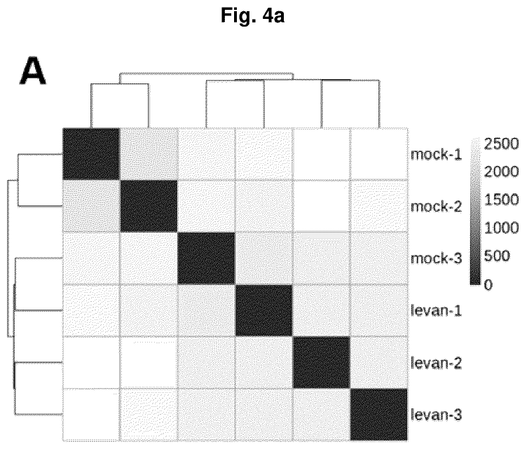

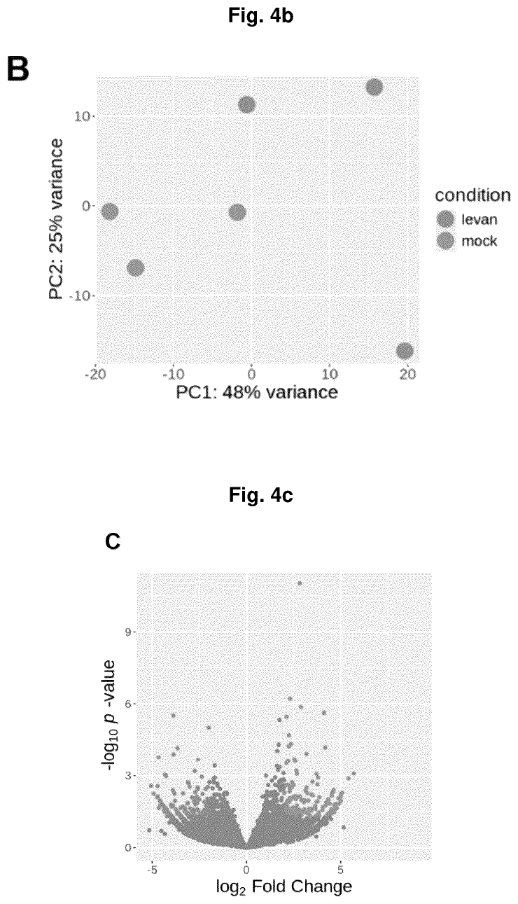

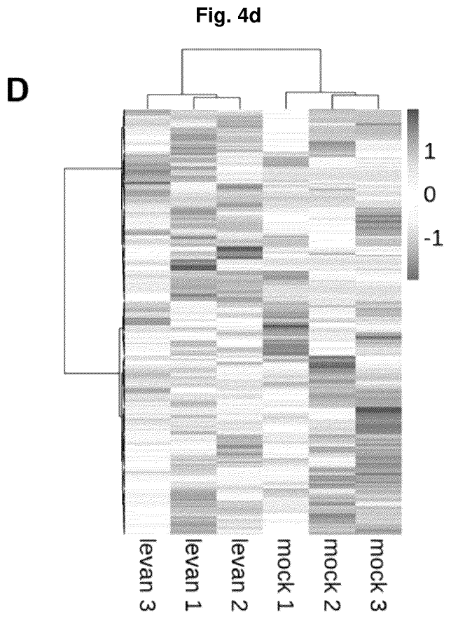

Tobacco plants treated with levan showed slight differences in global gene expression patterns compared to mock-treated plants (FIG. 4A). However, differences were observed within global gene expression patterns with PC1, accounting for 48% of the total variance (FIG. 4B). Based on these results, we identified differentially expressed genes (DEGs) between the two treatment groups. In plants treated with levan-containing inoculants, 163 DEG was significantly upregulated (p value<0.05; log₂ fold change [FC]>2), and 134 DEG was significantly downregulated (p value<0.05; log₂ FC<−2) (FIGS. 4C and 4D).

FIG. 4 shows the global gene expression pattern and differential expression gene (DEG) of the RNA-seq library according to the presence or absence of levan treatment.

Specifically, FIG. 4 shows the results of performing transcriptome analysis on the tobacco leaves that were not inoculated with CMV at 3 days post treatment with levan/distilled water (as a mock), and selecting genes whose expression was statistically significantly increased or decreased in the levan-containing culture media treatment group compared to the levan-free culture media treatment group.

The similarity of global gene expression patterns among RNA-seq libraries is presented using correlations (FIG. 4A) and PCA plots (FIG. 4B). Distance matrices between samples were calculated using the Canberra method for gene expression values transformed by variance stabilization transformations.

The analysis results of the gene expression patterns confirmed that the two treatment groups (levan-treated group and mock-treated group) influenced the overall gene expression pattern (FIGS. 4A and 4B).

As shown in FIGS. 4C and 4D, the gene expression patterns of DEGs between the levan-treated and mock-treated plants are represented by volcano and heatmap plots. DEG was selected using a threshold of p-value<0.05 and |log₂ fold change|>2. Blue and red dots represent significantly upregulated and downregulated genes, respectively (FIG. 4C).

It was confirmed that the expression of a total of 163 genes increased significantly in the levan-treated group compared to the mock-treated group, and also it was confirmed that the expression of 134 genes decreased significantly (FIGS. 4C and 4D).

To acquire more in-depth insights into the molecular mechanisms activated by levan treatment, we performed an analysis on candidate genes based on the genomic annotation of upregulated DEGs and downregulated DEGs.

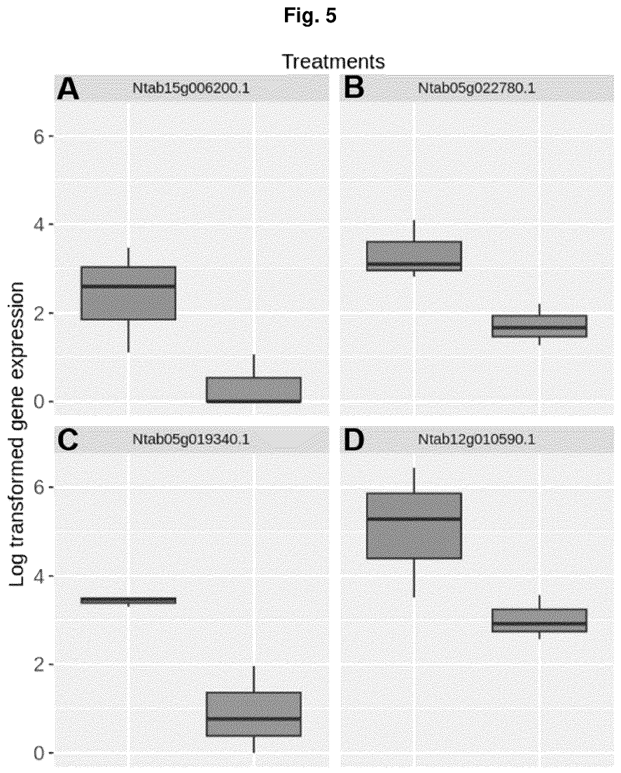

Interestingly, the genes associated with disease resistance were particularly enriched in the upregulated DEG (FIG. 5).

Specifically, one nucleotide-binding site-leucine-rich repeat (NBS-LRR) domain-containing disease-resistant protein coding gene (Ntab15g006200-1, homologous to AT3G 46530 encoding RECOGNITION OF PERONOSPORA 13 [RPP13]) was activated in the levan-treated plants (FIG. 5A). In addition, one transcriptional regulator (Ntab05g022780-1, homologous to AT5G55390) encoding ENHANCED DOWNY Mildew 2 (EDM2) (FIG. 5B) and two disease-resistant genes (Ntab05g019340-1 and Ntab12g010590-1) encoding pathogenesis-related (PR) family proteins were identified (FIGS. 5C and 5D).

FIG. 5 shows an expression pattern of a gene related to disease resistance according to the presence or absence of levan treatment. The gene expression patterns of disease resistance-associated genes are shown. These genes include Ntab15g006200-1 (FIG. 5A), which encodes RPP13, Ntab05g022780-1 (FIG. 5B), which encodes EDM2, Ntab05g019340-1, which encodes PR family proteins, and Ntab12g010590-1 (FIGS. 5C and 5D). The red and blue boxes represent levan and mock treatment conditions, respectively.

Specifically, FIG. 5 shows the result of analyzing the change in expression of genes that induce a defensive response to a pathogen among genes whose expression increases in tobacco leaves that are not inoculated with CMV 3 days after the treatment of the levan-containing culture media.

FIG. 5A shows the expression pattern of RECOGNITION OF PERONOSPORA PARASITICA 13(RPP13) coding gene (Ntab15g006200-1), FIG. 5B shows the expression pattern of ENHANCED DOWNY Mildew 2(EDM2) coding gene (Ntab05g022780-1), and FIGS. 5C and 5D show the expression patterns of pathogenesis related-(PR) family protein coding genes (Ntab05g019340-1 and Ntab12g010590-1).

It is considered that, by the increased expression of disease-resistant genes (a-d) related to the defense response in the levan-containing culture media treatment group, the levan treatment induces disease-resistant mechanisms through increased expression of disease-resistant genes.

Significant increases in expression of NBS-LRR genes and PR family protein-coding genes suggest that the levan treatment activated the defense mechanism against CMV in tobacco plants, as these family of genes are widely known as key factors in detecting pathogen attacks and activating plant defense responses (Han, Xiong, Schneiter, & Tian, 2023; McHale, Tan, Koehl, & Michelmore, 2006). In particular, RPP13, an NBS-LRR domain-containing gene, can play an important role in the mechanism of resistance against CMV infection, because the focus was on AtRPP13, an R gene that provides resistance against Pronospora parasitica in Arabidopsis thaliana in a salicylic acid (SA)-independent manner (Bittner-Eddy & Beynon, 2001; Bittner-Eddy, Crute, Holub, & Beynon, 2000). In particular, RCY1(RPP8), a gene homologous to RPP13, confers notable CMV resistance in Arabidopsis and N. benthamiana plants. In recent years, it was demonstrated that the coat protein (CP) of CMV-Y serves as a non-toxic factor in inducing RCY1-mediated hypersensitivity reactions (Takahashi et al., Ando, Kanayama, & Miyashita, 2024). RPP13 is the RPP protein family protein closest to RPP8 in Arabidopsis; therefore, it is considered that RPP13 activation may be involved in anti-CMV resistance induced by levan treatment. Furthermore, the transcriptional co-upregulation of EDM2 and RPP13 suggests that there may be a molecular linkage in priming disease resistance against CMV infection. The transcriptional level (Holub & Beyon, 1997) of RPP7, a homologue of RPP13, is regulated by the transcription factor EDM2, which contributes to disease resistance against the Hyaloperonospora parasitica isolate Hiks1 (HpHiks1) in Arabidopsis thaliana (Eulgem et al., 2007). EDM2 has a broad impact on the expression of other RPP family members, including RPP4 and RPP5, acting as a hub for managing resistance responses (Lai et al., 2020). It was found that the expression of EDM2 was significantly upregulated by levan treatment alone, without CMV infection (FIG. 5). Therefore, increased EDM2 appears to serve as a key antiviral priming factor that rapidly responds to viral invasion/infection and contributes to antiviral resistance. Additional functional genetic studies should be conducted to elucidate the association between EDM2 and RPP13 and their function to limit CMV infection.

Few previous studies have described antiviral resistance induced by Paenibacillus species. Kumar et al. (2016) demonstrated that soil inoculation with P. lentimorbus strain B-30488 promotes tobacco growth and enhances tolerance against CMV infection. The B-30488 inoculation activated several virus defense-related enzymes, including peroxidases, superoxide dismutase, and catalase (Kumar et al., 2016). More recently, the foliar application of culture filtrate of P. polymyxa SZYM conferred resistance against zucchini yellow mosaic virus in squash plants by increasing transcription levels of pathogenesis-related genes (Abdelkhalek, Al-Askar, Elbeaino, Moawad, & El-Gendi, 2022). However, these two strains were cultured in sucrose-free media. Therefore, it was concluded that the antiviral effect of B-30488 was not induced by EPSs such as levan, as suggested herein.

Similar to our results, another study revealed the antiviral effect of the EPS produced by P. kribbensis PS04 against tobacco mosaic virus in rice. EPS, also called fructosan (though not fully characterized as inulin or levan), induces resistance through the salicylic acid (SA) and jasmonic acid (JA)/ethylene (ET) pathways (Canwei et al., 2020). We identified that levan from P. polymyxa SG 09-12 has a remarkably long-lasting antiviral effect against CMV in tobacco, and identified several candidate genes activated by levan treatment, which may play a key role in the antiviral response. In particular, levan treatment activated the R gene through SA-independent resistance mechanisms in tobacco plants. As previously reported (Zhou et al., 2014), given that CMV 2b serves as an inhibitor of SA-mediated resistance, levan treatment may have been effective against CMV infection. Thus, our results suggest that levan produced by P. polymyxa SG09-12 is a sustainable and environmentally friendly antiviral agent that can be used for crop protection.

### 3. CONCLUSION

The production and characterization of levan produced by Paenibacillus polymyxa SG09-12 and its potential application as an antiviral agent against CMV have been presented.

The produced levan exhibited a high degree of purity, confirmed through HPLC, NMR, FT-IR and XPS analyses, indicating its homopolymeric nature composed predominantly of β-(2→6)-linked fructofuranosyl units.

The antiviral efficacy of levan was tested in tobacco plants, revealing that levan treatment significantly reduced CMV symptoms and viral RNA accumulation. It is shown herein that the treatment of tobacco leaves with levan strongly repressed CMV infection, providing a robust antiviral defense mechanism. To acquire deeper insight into antiviral mechanisms, the levan-treated and mock-treated tobacco plants were compared using global transcriptomic analysis, which identified promising candidate genes that could facilitate antiviral responses to CMV.

Overall, it is suggested herein that levan from P. polymyxa SG09-12 can be developed into an effective antiviral agent for agricultural use, contributing to improved crop resilience and productivity. Further research should explore the broader application of levan against other plant viruses and its potential integration into crop protection strategies.

Hereinafter, various Embodiments of the present disclosure will be described.

Embodiment 1. A composition for controlling plant viruses containing levan as an effective ingredient.

Embodiment 2. The composition for controlling plant viruses according to Embodiment 1, in which the plant viruses include tobacco mosaic virus (TMV), pepper mottle virus (PepMoV), cucumber mosaic virus (CMV), pepper mild mosaic virus (PMMoV), zucchini yellow mosaic virus (ZYMV), watermelon mosaic virus (WMV), watermelon mosaic virus 2(WMV2), potato virus Y (PVY), turnip mosaic virus (TuMV), melon necrotic spot virus (MNSV), cucumber green mottle mosaic virus (CGMMV), zucchini green mottle mosaic virus (ZGMMV), potato leafroll virus (PLRV), lily mottle virus (LMoV), lily symptomless virus (LSV), odontoglossum ringspot virus (ORSV), cymbidium mosaic virus (CyMV), broad bean wilt virus (BBWV), tomato ringspot virus (TomRSV), tobacco ringspot virus (TRSV), tomato spotted wilt virus (TSWV), strawberry mottle virus (SMoV), or cactus X virus (CVX).

Embodiment 3. The composition for controlling plant viruses according to Embodiment 2, in which the plant viruses include a cucumber mosaic virus (CMV).

Embodiment 4. The composition for controlling plant viruses according to Embodiment 1, in which the composition is in a form of liquid, powder, emulsion, oil, wettable powder, or spreader.

Embodiment 5. A pesticide composition with plant virus control activity including the composition for controlling plant viruses according to any one of Embodiments 1 to 4.

Embodiment 6. A composition for fertilizer additive with plant virus control activity including the composition for controlling plant viruses according to any one of Embodiments 1 to 4.

Embodiment 7. A method for controlling plant viruses including a step of treating plants or soil with the composition for controlling plant viruses according to any one of Embodiments 1 to 4.

Embodiment 8. The method according to Embodiment 7, in which the step of treating includes foliar application, soil treatment, immersion treatment, branch treatment, or agricultural equipment treatment.

What is claimed is:

1. A composition for controlling plant viruses containing levan as an effective ingredient.

2. The composition for controlling plant viruses according to claim 1, wherein the plant viruses include tobacco mosaic virus (TMV), pepper mottle virus (PepMoV), cucumber mosaic virus (CMV), pepper mild mosaic virus (PMMoV), zucchini yellow mosaic virus (ZYMV), watermelon mosaic virus (WMV), watermelon mosaic virus 2 (WMV2), potato virus Y (PVY), turnip mosaic virus (TuMV), melon necrotic spot virus (MNSV), cucumber green mottle mosaic virus (CGMMV), zucchini green mottle mosaic virus (ZGMMV), potato leafroll virus (PLRV), lily mottle virus (LMoV), lily symptomless virus (LSV), odontoglossum ringspot virus (ORSV), cymbidium mosaic virus (CyMV), broad bean wilt virus (BBWV), tomato ringspot virus (TomRSV), tobacco ringspot virus (TRSV), tomato spotted wilt virus (TSWV), strawberry mottle virus (SMoV), or cactus X virus (CVX).

3. The composition for controlling plant viruses according to claim 2, wherein the plant viruses include a cucumber mosaic virus (CMV).

4. The composition for controlling plant viruses according to claim 1, wherein the composition is in a form of liquid, powder, emulsion, oil, wettable powder, or spreader.

5. A pesticide composition with plant virus control activity including the composition for controlling plant viruses according to claim 1.

6. A composition for fertilizer additive with plant virus control activity including the composition for controlling plant viruses according to claim 1.

7. A method for controlling plant viruses including a step of treating plants or soil with the composition for controlling plant viruses according to claim 1.

8. The method according to claim 7, wherein the step of treating includes foliar application, soil treatment, immersion treatment, branch treatment, or agricultural equipment treatment.
